(19) United States
(12) Patent Application Publication
(10) Pub. No.: US 2004/0047794 A1
(43) Pub. Date: Mar. 11, 2004

(54) Fluidized bed reactor made of a nickel-chrome-molybdenum alloy for the synthesis of trichlorosilane

(76) Inventors: Matthias Pfaffelhuber, League City, TX (US); Rainer Weber, Odenthal (DE)

Correspondence Address: MCGLEW & TUTTLE, PC, 1 SCARBOROUGH STATION PLAZA, SCARBOROUGH, NY, 10510-0827, US

(21) Appl. No.: 10/451,211

(22) PCT Filed: Nov. 21, 2001
(86) PCT No.: PCT/EP01/13498

(30) Foreign Application Priority Data
Dec. 21, 2000 (DE) 100 63 863.5

(51) Int. Cl. B01J 8/18; C01B 33/107

(52) U.S. Cl. 423/342; 422/139; 422/240; 422/241

(57) ABSTRACT

The invention relates to a fluidized-bed reactor for the production of trichlorosilane by reacting silicon with silicon tetrachloride, hydrogen and optionally hydrogen chloride at a high pressure and high temperature. According to the invention, the fluidized-bed reactor, at least on the surface facing towards the reaction chamber, is made of a nickel-chrome-molybdenum-(NiCrMo)-alloy with a chrome proportion of at least 5 weight percent, an iron proportion of less than 4 weight percent and an additional proportion of 0-10 weight percent consisting of other alloy elements. The invention also relates to a method for producing trichlorosilane in said fluidized-bed reactor and to the use of said trichlorosilane.

The present invention relates to a fluidized-bed reactor for the manufacture of trichlorosilane by reacting silicon with silicon tetrachloride, hydrogen and, if necessary, hydrogen chloride at a high pressure and a high temperature, a method for the manufacture of trichlorosilane in that fluidized-bed reactor and the use of the trichlorosilane.

Trichlorosilane HSiCl₃ is a valuable intermediate product for producing high-purity silicon, dichlorosilane H₂SiCl₂, silane SiH₄ and organo-silicon compounds which are used, for example, as bonding agents. The methods used for producing trichlorosilane differ in technical terms.

From EP 658 359 A2 and DE 196 54 154 A1 it is known to hydrate silicon tetrachloride with hydrogen either at a high temperature or in the presence of catalysts.

In U.S. Pat. No. 4,676,967 it is mentioned to manufacture trichlorosilane by reacting silicon with hydrogen chloride in a fluidized bed at a temperature of approx. 300° C. From this a mixture is obtained that contains approx. 85% trichlorosilane and apart from this also silicon tetrachloride, dichlorosilane, metal halides and polysilanes. The execution of the method requires comparatively big reactors. In addition to this, the disposal of the by-products, particularly of the polysilanes, is expensive.

Reacting silicon with silicon tetrachloride and hydrogen to trichlorosilane in a temperature range from 400° C. to 600° C. is known from “Studies in Organic Chemistry 49, Catalyzed Direct Reactions of Silicon, Elsevier, 1993, p. 450 to 457”, U.S. Pat. No. 4,676,967 and CA-A-1,162,028. This method gained particular importance in those cases, where the further processing of trichlorosilane results inevitably in the production of silicon tetrachloride, because in that case the inevitably produced silicon tetrachloride can be re-transformed directly and advantageously into trichlorosilane. This is the case, for example, in the manufacture of dichlorosilane and of silane by disproportionation of trichlorosilane.

This method can be integrated as a partial step in various more comprehensive continuous processes, e.g. in processes for producing silane or hyper-pure silicon.

For example in U.S. Pat. No. 4,676,967 and CA-A-1,162,028 methods for producing hyper-pure silane and high-purity silicon are disclosed, wherein in a first step metallurgical silicon is reacted with hydrogen and silicon tetrachloride to trichlorosilane. The reaction is carried out at temperatures from approx. 400 to 600° C. and under increased pressure above 100 psi (6.89 bar). The reaction under increased pressure is necessary in order to increase the yield of trichlorosilane. In a subsequent step trichlorosilane is disproportionated to silane. This results inevitably in the production of silicon tetrachloride which is recycled and introduced again to be reacted with hydrogen and metallurgical silicon. Finally the produced silane can be thermally decomposed to hyper-pure silicon and hydrogen.

The reaction conditions at the manufacture of trichlorosilane in a fluidized-bed reactor, the resulting products and by-products, particularly hydrogen chloride and the attrition caused by the silicon particles which are fluidized in the fluidized bed call for a high standard of stability of the construction materials of the reactor and the preceding and secondary parts of the plant, as for example cyclones or heat exchangers.

According to “Mui, J. Y. P., Corrosion (Houston), 41 (2), 63-69” and “Studies in Organic Chemistry 49, Catalyzed Direct Reactions of Silicon, E1-sevier, 1993, p. 454” suitable construction materials for a fluidized-bed reactor for a reaction temperature of 500° C. are materials containing chrome and/or molybdenum, e.g. special steel, Incoloy® 800H and Hastelloy® B-2, and for a reaction temperature of 820 K (547° C.) Fe base alloy Incoloy® 800H and nickel base alloy Hastelloy® C-276. However, particularly the Ni base alloys are not unrestrictedly suitable as materials for pressure vessels, particularly because the higher temperatures cause a brittleness of the materials. According to “Studies in Organic Chemistry 49, Catalyzed Direct Reactions of Silicon, Elsevier, 1993, p. 454”, at higher reaction temperatures which are advantageous for reacting silicon with silicon tetrachloride and hydrogen, the materials must be protected by means of a silicon-carbide coating (SiC) against excessive corrosion, a fact that increases the costs for a fluidized bed reactor of that construction type drastically.

The object of the present invention was to provide a method for the manufacture of trichlorosilane in a fluidized-bed reactor and a suitable fluidized-bed reactor, wherein the fluidized-bed reactor consists of a material providing a good corrosion resistance in a reaction of silicon with silicon tetrachloride, hydrogen and, if necessary, hydrogen chloride at a high pressure and high temperature (T>550° C.).

It was now found that fluidized-bed reactors made of NiCrMo alloys containing a sufficiently high percentage of chrome, a percentage of less than 4 weight percent iron calculated as metal, and an additional percentage of 0-10 weight percent calculated as element, of other alloy elements, provide a superior corrosion resistance under the reaction conditions prevailing during the reaction of silicon with silicon tetrachloride and hydrogen.

Subject-matter of the invention is therefore a fluidized-bed reactor for the reaction of silicon with silicon tetrachloride and hydrogen, characterized in that at least that surface of the fluidized-bed reactor facing the reaction chamber is made of a NiCrMo alloy containing a percentage of at least 5 weight percent chrome, a percentage of less than 4 weight percent iron and an additional percentage of 0-10 weight percent of other alloy elements.

Fluidized-bed reactors in which at least that surface of the fluidized-bed reactor facing the reaction chamber is made of NiCrMo alloys containing a percentage of at least 5 weight percent chrome, a percentage of 0-1.5 weight percent iron and an additional percentage of 0-10 weight percent of other alloy elements are particularly suitable.

Suitable NiCrMo alloys are available in the market, for example, under the commercial names Inconel® 617, Inconel® 625, Alloy 59 and MITSUBISIHI ALLOY® T21. The use of the material Alloy 59 or MITSUBISIHI ALLOY® T21 is preferred.

Preferred are fluidized-bed reactors in which NiCrMo alloys containing a percentage of at least 5 weight percent chrome, a percentage of less than 4 weight percent iron and an additional percentage of 0-10 weight percent of other alloy elements are applied in form of a corrosion-resisting roll-bonded cladding, explosive cladding or weld cladding on a metallic material (heat-resisting materials, Fe or Ni base alloy) that is not sufficiently corrosion-resisting in the present medium.

Preferred are fluidized-bed reactors in which NiCrMo alloys containing a percentage of at least 5 weight percent chrome, a percentage of 0-1.5 weight percent iron and an additional percentage of 0-10 weight percent of other alloy elements are applied in form of a corrosion-resisting roll-bonded cladding, explosive cladding or weld cladding, e.g. consisting of Alloy 59, on a metallic material (heat-resisting materials, Fe or Ni base alloy) that is not sufficiently corrosion-resisting in the present medium.

The application of fluidized-bed reactors according to the invention, e.g. reactors which are made of Inconel® 617 or which are provided with a corrosion-resisting roll-bonded cladding, explosive cladding or weld-cladding, made of Alloy 59, on a metallic material (heat-resisting materials, Fe or Ni base alloy) that is not sufficiently corrosion-resisting in the present medium, enables a continuous operation of the fluidized-bed reactors for the manufacture of trichlorosilane even at temperatures above 600° C.

Another subject-matter of the invention is a method for the manufacture of trichlorosilane by reacting silicon with silicon tetrachloride, hydrogen and, if necessary, hydrogen chloride at a pressure from 20 to 40 bar, characterized in that the reaction is carried out in a fluidized-bed reactor according to the invention at a temperature from 400 to 800° C.

Preferably the method according to the invention is carried out at a pressure from 30 to 40 bar.

A reaction temperature from 500 to 700° C. is preferred.

In the method according to the invention any type of silicon can be used. For example metallurgical silicon can be used. Metallurgical silicon in this meaning refers to silicon containing up to approx. 3 weight percent iron, 0.75 weight percent aluminum, 0.5 weight percent calcium and other impurities as can usually be found in silicon obtained by carbothermal reduction of silicon.

Preferably silicon provided in granular form, particularly preferred with an average grain diameter of 10 to 1000 μm, more particularly preferred of 100 to 600 μm, is used. The average grain diameter is calculated as the arithmetical mean of the values determined in a sieve analysis of the silicon.

The mol ratio of hydrogen to silicon tetrachloride in the reaction according to the invention can be for example 0.25:1 to 4:1. A mol ratio of 0.6:1 to 2:1 is preferred.

During the reaction according to the invention hydrogen chloride can be added, and the amounts of hydrogen chloride can be varied over a wide range. Preferably an amount of hydrogen chloride is added such that a mol ratio of silicon tetrachloride to hydrogen chloride of 1:0 to 1:10, particularly preferred of 1:0 to 1:1, is obtained.

The addition of hydrogen chloride is preferred.

It is possible to add catalyst in the method according to the invention. On principle, all catalysts known for reacting silicon with silicon tetrachloride, hydrogen and, if necessary, hydrogen can be used as catalyst.

Particularly suitable catalysts for the method according to the invention are copper catalysts and iron catalysts. Examples for this are copper oxide catalysts (e.g. Cuprokat®, manufacturer: Norddeutsche Affinerie), copper chloride (CuCl CuCl₂), copper metal, iron oxides (e.g. Fe₂O₃, Fe₃O₄), ferrous chlorides (e.g. FeCl₂, FeCl₃) and their mixtures.

Preferred catalysts are copper oxide catalysts and iron oxide catalysts.

It is also possible to use mixtures of copper catalysts and/or iron catalysts with further catalytically active components. Such catalytically active components are, for example, metal halogenides, such as e.g. chlorides, bromides or iodides of aluminum, vanadium or antimony.

Preferably the amount of catalyst used, calculated as metal, is 0.5 to 10 weight percent, particularly preferred 1 to 5 weight percent, based on the silicon employed.

The trichlorosilane produced according to the method according to the invention can be used, for example, for the manufacture of silane and/or hyper-pure silicon.

Therefore the invention also relates to a method for producing silane and/or hyper-pure silicon on the basis of trichlorosilane obtained according to the method specified above.

Preferably the method according to the invention is integrated into a general method for producing silane and/or hyper-pure silicon.

It is particularly preferred that the method according to the invention be integrated into a method for producing silane and/or hyper-pure silicon comprising the following steps:

1. Trichlorosilane synthesis according to the method according to the invention and subsequent isolation of the produced trichlorosilane by distillation and recycling of the unreacted silicon tetrachloride, and, if desired, the unreacted hydrogen;

2. Disproportionation of trichlorosilane to silane and silicon tetrachloride through the intermediate stages of dichlorosilane and monochlorosilane on basic catalysts, preferably catalysts containing amino groups, carried out in two apparatuses or in one, and recirculation of the produced silicon coming out as a high-boiling component into the first reaction area.

3. Further use of the silane of the purity given after the preceding step, or purifying the silane until the purity required for the intended purpose is achieved, preferably by distillation, particularly preferred by distillation under pressure.

and, if necessary,

4. Thermal decomposition of silane to obtain high-purity silicon, usually above 500° C. Apart from thermal decomposition on electrically heated high-purity silicon rods, another suitable method is the thermal decomposition in a fluidized bed consisting of hyper-pure silicon particles, particularly when the production of solar-grade high-purity purity silicon is desired. To this aim, silane can be mixed with hydrogen and/or inert gases at a mol ratio of 1:0 to 1:10.

In the following the excellent suitability of the nickel-chrome-molybdenum alloy (NiCrMo alloy) containing a percentage of at least 5 weight percent chrome, a percentage of less than 4 weight percent iron and an additional percentage of 0-10 weight percent of other alloy elements, that is to be employed according to the invention as construction material for a fluidized-bed reactor for the reaction of silicon with silicon tetrachloride and hydrogen, shall be demonstrated with reference to an example.

### EXAMPLE 1

Samples of the materials named in Table 1 were abraded using (120 grade) abrasive paper and exposed to a gas mixture consisting of SiCl₄ and H₂, the ratio of their volumes being 3:2 at a pressure of 1 bar in three experimental runs. The samples were exposed to the gas mixture: at a temperature of 600° C. for a period of 400 h in the first experimental run, at a temperature of 700° C. for a period of 400 h in the second experimental run, and at a temperature of 600° C. for a period of 1000 h in the third experimental run. The materials AISI 316L, Hastelloy® C-276 and Hastelloy® B-3 are no materials to be used according to the invention and were examined for comparison.

The flow rates in the individual tests were between 2.8 to 11.5 l/h.

TABLE 1
Employed materials, essential alloy elements (in weight percent)

| Material | Mat. no | Cr | Mo | Ni | Fe | Nb/Ta | Co | W | Si | Al |
|---|---|---|---|---|---|---|---|---|---|---|
| AISI 316L | | 18.5 | 2.1 | 11.25 | Bal. | | | | | 1 |
| Hastelloy ® C-276 | 2,4819 | 15.2 | 15.54 | Bal. | 6.71 | | | 3-4 | <0.01 | |
| Hastelloy ® B-3 | | <1.5 | 28.5 | Bal. | 1.5 | | <3 | | <0.1 | |
| Inconel ® 625 | 2,4856 | 22.45 | 8.88 | Bal. | 1.65 | 3.5 | 0.6 | | 0.06 | 0.13 |
| Alloy 59 | 2,4605 | 22.5 | 15.9 | Bal. | 0.23 | | | | 0.02 | 0.25 |
| MITSUBISHI | | 18-20 | 18-20 | Bal. | <1.0 | | | | 0.08 | |
| ALLOY ® T-21 | | | | | | | | | | |

mat. no.: material number
Bal.: percentage missing for a total of 100 weight percent.

After the treatment of the samples the thickness of the corrosion coating including the area of the interior damage caused to the material were determined by means of microsection/metallographic section. The results are summarized in Table 2.

TABLE 2

| T | | | |
|---|---|---|---|
| | Thickness of | Thickness of | Thickness of |
| | coating + | coating + | coating + |
| | interior damage | interior damage | interior damage |
| | [μm] | [μm] | [μm] |
| Material | 600° C., 400 h | 600° C., 1000 h | 700° C., 400 h |
| AISI 316L | 100 | 135 | 200 |
| Hastelloy ® C-276 | 35 | 45 | 75 |
| Hastelloy ® B-3 | 75 | — | 175 |
| Inconel ® 625 | 25 | 30 | 50 |
| Alloy 59 | 20 | 30 | 40 |
| MITSUBISHI | — | 20 | — |
| ALLOY ® T-21 | | | |

1. A fluidized-bed reactor for the reaction of silicon with silicon tetrachloride and hydrogen, characterized in that at least that surface of the fluidized-bed reactor facing the reaction chamber is made of a nickel-chrome-molybdenum alloy (NiCrMo alloy) containing a percentage of at least 5 weight percent chrome, a percentage of less than 4 weight percent iron and an additional percentage of 0-10 weight percent of other alloy elements.

2. A fluidized-bed reactor according to claim 1, characterized in that the NiCrMo alloy has a percentage of 0-1.5 weight percent iron.

3. A fluidized-bed reactor according to at least one of claims 1 and 2, characterized in that the NiCrMo alloy is applied on a metallic material in form of a corrosion-resisting roll-bonded cladding, explosive cladding or weld-cladding.

4. A method for the manufacture of trichlorosilane by reacting silicon with silicon tetrachloride, hydrogen and, if necessary, hydrogen chloride, characterized in that the reaction is carried out in a fluidized-bed reactor according to at least one of claims 1 to 3 at a pressure from 20 to 40 bar and a temperature from 400 to 800° C.

5. A method according to claim 4, characterized in that the reaction is carried out at a pressure of 30 to 40 bar.

6. A method according to at least one of claims 4 to 5, characterized in that the reaction is carried out at a temperature from 500 to 700° C.

7. A method for producing silane ands/or hyper-pure silicon, characterized in that the starting material is trichlorosilane obtained according to at least one of claims 4 to 6.
